(19) United States
(12) Patent Application Publication
(10) Pub. No.: US 2022/0018156 A1
(43) Pub. Date: Jan. 20, 2022

(54) RACK-AND-PINION HANDLE SYSTEM

(71) Applicant: Arconic Technologies LLC, Pittsburgh, PA (US)

(72) Inventors: Kyle A. McDaniel, Johns Creek, GA (US); Thomas Y. Cheng, Atlanta, GA (US); Pranav Chunduri, Cary, NC (US); Jason Paulose, Lilburn, GA (US); Sai Srinivas, Marietta, GA (US); Gonzalo A. Barreto, Weston, FL (US); Jacob Z. Thomas, Lilburn, GA (US)

(73) Assignee: Arconic Technologies LLC, Pittsburgh, PA (US)

(21) Appl. No.: 17/294,737

(22) PCT Filed: Nov. 25, 2019
(86) PCT No.: PCT/US2019/063038

§ 371 Date: May 18, 2021

Related U.S. Application Data
(60) Provisional application No. 62/771,760, filed on Nov. 27, 2018.

(51) Int. Cl. E05B 17/00; E05B 1/00; E05F 11/54; E05B 7/00; E06B 3/46

(52) U.S. Cl. CPC E05B 17/0033; E05B 1/0015; E06B 3/4636; E05B 7/00; E05F 11/54

(57) ABSTRACT

A sliding door system includes a stationary door frame, a sliding door panel installed in the stationary door frame and movable between a closed and open position, and a handle assembly coupled to the sliding door panel. The handle assembly includes a rack housing installed within a vertical stile of the sliding door panel, a rack positioned within the rack housing and movable between stowed and extended positions, and a handle operatively coupled to a pinion engageable with the rack, the handle being pivotable about a pivot axis between first and second positions. Rotating the handle from the first position to the second position causes the pinion to move the rack to the extended position and into engagement with the stationary door frame, whereby the sliding door frame is forced away from the stationary door frame from the closed position to the open position.

### BACKGROUND

Opening and moving sliding glass doors is oftentimes difficult, especially for the elderly and individuals suffering from mobility issues. The difficulty can be amplified with sliding glass doors installed in high-rise buildings and beach properties, where there is a high-pressure differential between the exterior and interior of the building.

The 2010 Americans with Disabilities Act (ADA) Standards for Accessible Design specifies a 5 lb. maximum limit of user input force to operate sliding glass doors. The ADA standards also mandate that tight gripping and twisting of the wrist not be required to operate the handle. If a user has rheumatoid arthritis, for example, inflammation of joints may make twisting motion of the door painful or even impossible.

With a growing portion of the population being elderly people or people with mobility issues, it is desired to develop a technology to assist with opening heavy sliding glass doors.

### SUMMARY OF THE DISCLOSURE

Embodiments disclosed herein include a sliding door system that includes a stationary door frame, a sliding door panel installed in the stationary door frame and movable between a closed position and an open position, and a handle assembly coupled to the sliding door panel. The handle assembly including a rack housing installed within a vertical stile of the sliding door panel, a rack positioned within the rack housing and movable between a stowed position and an extended position, and a handle operatively coupled to a pinion engageable with the rack, the handle being pivotable about a pivot axis between a first position and a second position, wherein rotating the handle from the first position to the second position causes the pinion to move the rack to the extended position and protrude from the rack housing and the vertical stile, whereby the rack is moved into engagement with the stationary door frame and the sliding door frame is thereby forced away from the stationary door frame from the closed position to the open position. In a further embodiment, the sliding door system may include a weathered channel provided on a side member of the stationary door frame, the vertical stile being partially receivable within the weathered channel when the sliding door panel is in the closed position, and wherein moving the rack to the extended position engages the rack on the side member and thereby disengages the vertical stile from the weathered channel. In another further embodiment of any of the previous embodiments, the handle assembly further includes a trim plate coupled to the vertical stile, and a pin secured to the trim plate, wherein the pivot axis extends through the pin. In another further embodiment of any of the previous embodiments, the handle assembly further includes a pinion shaft extending laterally from the handle and through the trim plate via an aperture, and wherein the pinion shaft extends from the handle to the pivot axis, and the pinion extends from the pivot axis to engage the rack. In another further embodiment of any of the previous embodiments, a ratio between a length of the pinion shaft from the pivot axis and a length of the pinion from the pivot axis results in a mechanical advantage of at least 2.40. In another further embodiment of any of the previous embodiments, the handle assembly further includes a pinion spindle rotatably mounted to the pin, wherein an end of each of the pinion shaft and the pinion are coupled to the pinion spindle to transfer torque between the pinion shaft and the pinion. In another further embodiment of any of the previous embodiments, the handle assembly further includes a helical coil spring operatively coupled to the pinion spindle and extending about the pin. In another further embodiment of any of the previous embodiments, the handle is a first handle mounted on a first side of the vertical stile, the pivot axis is a first pivot axis, the rack is a first rack, and the pinion is a first pinion, and wherein the handle assembly further includes a second rack positioned within the rack housing and movable between a stowed position and an extended position, and a second handle mounted on a second side of the vertical stile and operatively coupled to a second pinion engageable with the second rack, the second handle being pivotable about a second pivot axis between a first position and a second position, wherein rotating the second handle from the first position to the second position causes the second pinion to move the second rack to the extended position and into engagement with the stationary door frame, whereby the sliding door frame is forced away from the stationary door frame from the closed position to the open position.

Embodiments disclosed herein may further include a method of operating a sliding door system that includes placing a load on a handle of handle assembly coupled to a sliding door panel installed in a stationary door frame, the handle assembly including a rack housing installed within a vertical stile of the sliding door panel, and a rack positioned within the rack housing and movable between a stowed position and an extended position, wherein the handle is operatively coupled to a pinion engageable with the rack. The method may further include pivoting the handle about a pivot axis from a first position to a second position and thereby moving the rack to the extended position and into engagement with the stationary door frame, and forcing the sliding door frame away from the stationary door frame with the rack and thereby moving the sliding door frame from the closed position to the open position. In a further embodiment, a weathered channel is provided on a side member of the stationary door frame, the method further comprising partially receiving the vertical stile within the weathered channel when the sliding door panel is in the closed position, moving the rack toward the extended position and thereby engaging the rack on the side member, and disengaging the vertical stile from the weathered channel as the rack moves to the extended position. In a further embodiment, the handle assembly further includes a trim plate coupled to the vertical stile, a pin secured to the trim plate and having the pivot axis extend therethrough, and a pinion shaft extending laterally from the handle and through the trim plate, wherein the pinion shaft extends from the handle to the pivot axis, and the pinion extends from the pivot axis to engage the rack. In a further embodiment, the method further includes obtaining a mechanical advantage of at least 2.40 based on a ratio between a length of the pinion shaft from the pivot axis and a length of the pinion from the pivot axis. In a further embodiment, the handle assembly further includes a pinion spindle rotatably mounted to the pin and an end of each of the pinion shaft and the pinion are coupled to the pinion spindle, the method further comprising transferring toque between the pinion shaft and the pinion with the pinion spindle. In a further embodiment, the handle assembly further includes a helical coil spring operatively coupled to the pinion spindle and extending about the pin, the method further comprising building spring force in the helical coil spring as the handle moves from the first position to the second position, removing the load on the handle, releasing the spring force in the helical coil spring and thereby moving the handle from the second position to the first position, and moving the rack back to the stowed position as the handle moves from the second position to the first position. In a further embodiment, the handle assembly further includes a roller grip incorporated into the handle, the method further comprising rotating the roller grip about the handle as the handle pivots from the first position to the second position.

Embodiments disclosed herein may further include a handle assembly for a sliding door panel of a sliding door system, the handle assembly may include a rack housing configured to be installed within a vertical stile of the sliding door panel, a rack configured to be positioned within the rack housing and movable between a stowed position and an extended position, and a handle operatively coupled to a pinion engageable with the rack, the handle being pivotable about a pivot axis between a first position and a second position, wherein rotating the handle from the first position to the second position causes the pinion to move the rack to the extended position and protrude from the rack housing and the vertical stile. In a further embodiment, the handle assembly further includes a trim plate coupled to the vertical stile, a pin secured to the trim plate, wherein the pivot axis extends through the pin, a pinion shaft extending laterally from the handle and through the trim plate via an aperture, wherein the pinion shaft extends from the handle to the pivot axis, and the pinion extends from the pivot axis to engage the rack. In a further embodiment, a ratio between a length of the pinion shaft from the pivot axis and a length of the pinion from the pivot axis results in a mechanical advantage of at least 2.40. In a further embodiment, the handle assembly further includes a pinion spindle rotatably mounted to the pin, and a helical coil spring operatively coupled to the pinion spindle and extending about the pin, wherein an end of each of the pinion shaft and the pinion are coupled to the pinion spindle to transfer torque between the pinion shaft and the pinion. In a further embodiment, the handle includes a roller grip.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIGS. 1A and 1B are front views of an example sliding door system, according to one or more embodiments.

FIGS. 2A and 2B are right and left isometric views, respectively, of a portion of the sliding door system of FIGS. 1A-1B.

FIGS. 3A and 3B are enlarged left and right isometric views, respectively, of the handle assembly of FIGS. 1A-1B and 2A-2B, according to one or more embodiments.

FIGS. 4A and 4B are left and right isometric views, respectively, of the handle assembly of FIGS. 3A-3B.

FIGS. 5A-5C are partial cross-sectional top views of the handle assembly in example operation, according to one or more embodiments.

FIGS. 6A-6C are partial cross-sectional top views of the handle assembly in example operation, according to one or more embodiments.

### DETAILED DESCRIPTION

The present disclosure is related to sliding glass doors and, more particularly, to handle assemblies for sliding glass doors that provide a mechanical advantage.

Embodiments discussed herein describe technology developed to assist with opening heavy sliding glass doors. The 2010 Americans with Disabilities Act (ADA) Standards for Accessible Design specifies a 5 lb. maximum limit of user input force to operate sliding glass doors. The present disclosure describes mechanically advantaged handle assemblies for sliding glass doors that comply with ADA standards. The handle assemblies described herein are developed for use in existing sliding door products and provide a mechanical advantage that multiplies the user input force necessary to disengage the door from the frame and rolling force. Consequently, existing sliding door products can be retrofitted with the presently disclosed handle assemblies to make the sliding door product ADA compliant. Alternatively, the handle assemblies described herein may be installed in new sliding door products to achieve ADA compliance.

One example sliding door system disclosed herein includes a stationary door frame, a sliding door panel installed in the stationary door frame and movable between a closed and open position, and a handle assembly coupled to the sliding door panel. The handle assembly can include a rack housing installed within a vertical stile of the sliding door panel, a rack positioned within the rack housing and movable between stowed and extended positions, and a handle operatively coupled to a pinion engageable with the rack, the handle being pivotable about a pivot axis between first and second positions. Rotating the handle from the first position to the second position causes the pinion to move the rack to the extended position and into engagement with the stationary door frame, whereby the sliding door frame is forced away from the stationary door frame from the closed position to the open position. Rotating the handle may be designed with the ergonomic intention of user intuitiveness due to the ability for the user to disengage the door with a mechanical advantage obtained via the handle assembly described herein, and subsequently apply the rolling force to continue the opening process with one continuous motion.

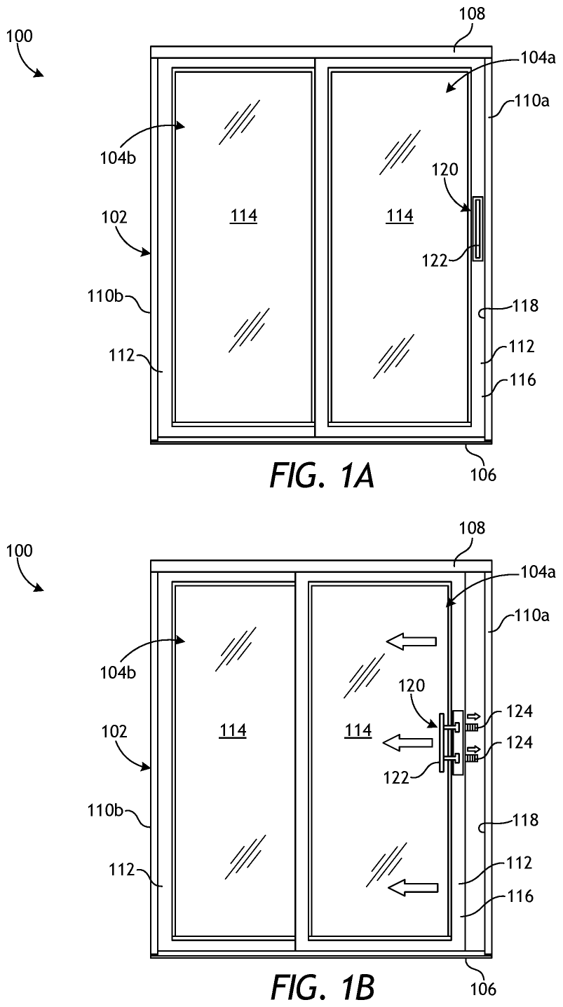

FIGS. 1A and 1B are front views of an example sliding door system 100, according to one or more embodiments. More specifically, FIG. 1A shows the sliding door system 100 (hereafter the “system 100”) in a closed position (alternately referred to as the “sealed” position), and FIG. 1B shows the system 100 in an open position (alternately referred to as the “sliding” or “rolling” position). While the following description is directed to sliding door systems, the principles of the present disclosure are equally applicable to sliding window systems or assemblies.

As illustrated, the system 100 includes a door frame 102 that supports a sliding door panel 104a and a stationary door panel 104b. The door frame 102 includes a bottom member 106, a top member 108, and opposing first and second side members 110a and 110b that extend between the bottom and top members 106, 108. The door frame 102 may be installed in any residential or commercial building, and the sliding and stationary door panels 104a,b may be installed in the door frame 102 to separate the outside (exterior) environment from the inside (interior) environment.

The sliding door panel 104a is designed to move (e.g., slide, roll, translate, etc.) relative to the door frame 102 and the stationary door panel 104b, which remain static. The sliding and stationary door panels 104a,b may each include a frame 112 that surrounds a window pane 114. The window panes 114 may each comprise one or more panes of window glass, one or more panes of polycarbonate, or one or more panels of material that are clear, translucent, tinted, or opaque. Those skilled in the art will readily appreciate that other general designs and/or configurations for the sliding and stationary door panels 104a,b may alternatively be employed in the system 100, without departing from the scope of the disclosure.

When in the closed position, the sliding door panel 104a may be substantially sealed about its periphery such that the migration (leakage) of air, water, and/or debris about the perimeter of the frame 112 is largely prevented. Moreover, in the closed position, a portion of a vertical stile 116 of the frame 112 of the sliding door panel 104a may be partially received within a vertical weathered channel 118 defined by the first side member 110a. The weathered channel 118 may have a depth of about 0.5 inches to about 1.0 inches to receive the adjacent vertical stile 116 of the frame 112. In some embodiments, one or more gaskets or seals, sometimes referred to as “weathering piles,” may be arranged within the weathered channel 118 to seal against the vertical stile 116 protruding into the weathered channel 118.

To help transition the sliding door panel 104a between the closed and open (sliding) positions, the system 100 includes a handle assembly 120, which includes a handle 122 that is manually articulable between a first position, as shown in FIG. 1A, and a second position, as shown in FIG. 1B. In the first position, the handle 122 is positioned generally adjacent the first side member 110a, and in the second position the handle 122 is pivoted away from the first side member 110a by a user placing a load on the handle 122 in the direction indicated by the arrow.

As discussed above, the Americans with Disabilities Act (ADA) specifies a 5 lb. maximum limit of user input force to operate (i.e., open and roll) a sliding glass door, such as the sliding door panel 104a. Because of its weight and sealed engagement about its periphery and especially within the weathered channel 118, moving the sliding door panel 104a from the closed position to the open position can require over 12 lbs. of user input force. According to embodiments of the present disclosure, however, the design and configuration of the handle assembly 120 provides a mechanical advantage that multiplies the user input force to a level sufficient to disengage the sliding door panel 104a from the weathered channel 118 within ADA limits. In some embodiments, for example, the handle assembly 120 is capable of providing a mechanical advantage of about 2.40, which converts about 5 lbs. of user input force to approximately 12 lbs. of force, which is enough to disengage the sliding door panel 104a from the weathered channel 118, thus making the system 100 ADA compliant and easier for a user to move the sliding door panel 104a from the closed position to the open position.

As described in more detail below, moving the handle 122 to the second position helps transition the sliding door panel 104a from the closed position to the open position and, more particularly, helps disengage the vertical stile 116 from the weathered channel 118. The handle assembly 120 may be configured as or otherwise include an internal rack-and-pinion system, where the handle 122 operates one or more pinions (not shown) engageable with one or more racks 124 (two shown) stowed within the vertical stile 116 of the frame 112. Manual movement of the handle 122 to the second position, as shown in FIG. 1B, causes the rack(s) 124 to move from the stowed position to an extended position where the rack(s) 124 protrude laterally out of the vertical stile 116 to bear against the laterally adjacent first side member 110a. The protruding rack(s) 124 apply a disengagement force against the first side member 110a that drives the sliding door panel 104a away from the first side member 110a and to the open position. Once in the open position, only about 5 lbs. of user input force is needed to continue moving (rolling) the sliding door panel 104a to a fully open position.

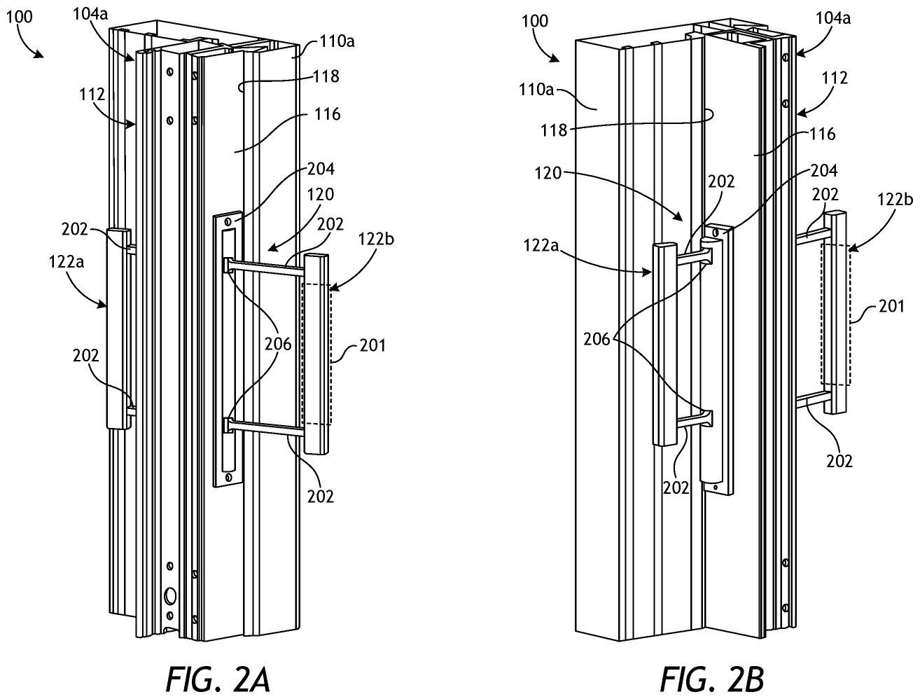

FIGS. 2A and 2B are right and left isometric views, respectively, of a portion of the system 100 of FIGS. 1A-1B. More specifically, FIGS. 2A and 2B depict right and left isometric views, respectively, of the handle assembly 120 as installed in the vertical stile 116 of the frame 112 of the sliding door panel 104a. The window pane 114 (FIG. 1) is omitted in FIGS. 2A-2B for ease of viewing. The sliding door panel 104a is depicted in the closed position with a portion of the vertical stile 116 received within the vertical weathered channel 118 defined by the first side member 110a.

In the illustrated embodiment, the handle assembly 120 includes a first or “interior” handle 122a mounted to the stile 116 on the interior side of the sliding door panel 104a, and a second or “exterior” handle 122b mounted to the stile 116 on the exterior side of the sliding door panel 104a. In other embodiments, however, the handle assembly 120 may include only one of the first or second handles 122a,b, without departing from the scope of the disclosure. In the illustrated embodiment, the handles 122a,b are each vertically-mounted and extend substantially parallel to the first side member 110a.

In some embodiments, one or both of the handles 122a,b may incorporate a roller grip 201 (shown in dashed lines on the second handle 122b) that has freedom to rotate so a user is not required to twist his/her wrist while applying force to rotate the handles 122a,b and thereby activate the handle assembly 120.

Each handle 122a,b includes one or more pinion shafts 202 that extend laterally from the corresponding handle 122a,b and into the interior of the stile 116. While the illustrated embodiment depicts two pinion shafts 202 included with each handle 122a,b, more or less than two may be employed, without departing from the scope of the disclosure. In some embodiments, the handle assembly 120 may further include a trim plate 204 (alternately referred to as an “escutcheon plate”) mounted to the interior and exterior sides of the stile 116, and each pinion shaft 202 may pass through or otherwise penetrate the associated trim plate 204 via a corresponding aperture 206 defined in the associated trim plate 204.

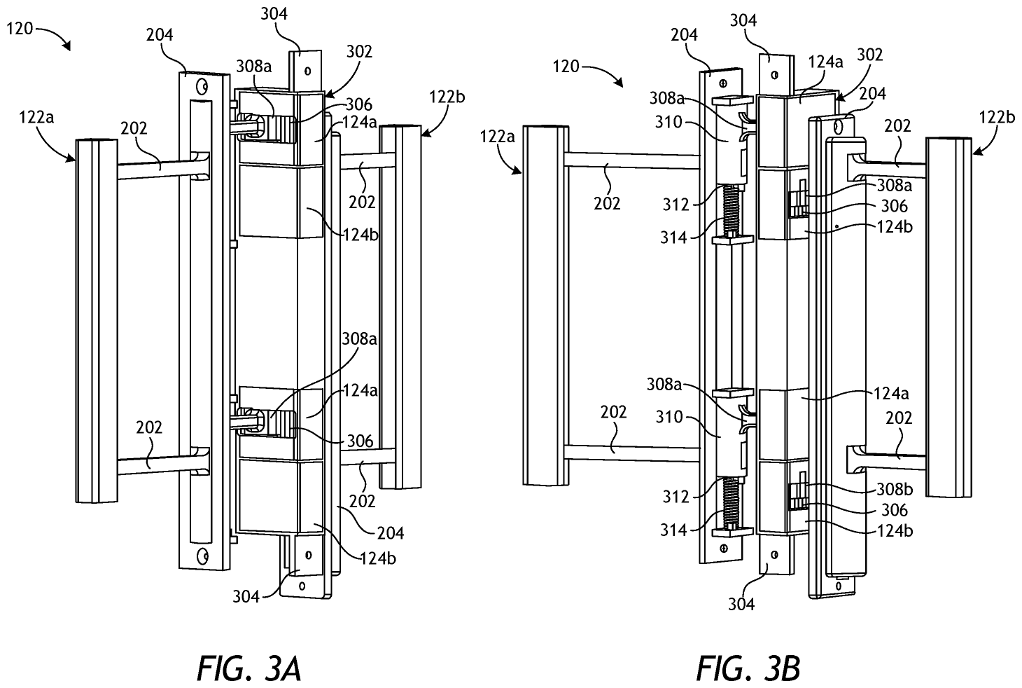

FIGS. 3A and 3B are enlarged left and right isometric views, respectively, of the handle assembly 120 of FIGS. 1A-1B and 2A-2B. As illustrated, the handle assembly 120 further includes a rack housing 302 that may be mounted within the vertical stile 116 (FIGS. 1A-1B and 2A-2B). In some embodiments, for example, a mortice cut may be made in the endwall of the stile 116 and the rack housing 302 may be arranged within the mortice cut. The rack housing 302 may be made of a variety of rigid materials including, but not limited to, a metal (e.g., stainless steel, brass, etc.) or a polymer. In at least one embodiment, the rack housing 302 may include one or more tabs 304 extending from the rack housing 302 and providing a location where the rack housing 302 may be mechanically fastened to the stile 116, such as by using one or more mechanical fasteners (e.g., screws, rivets, etc.). In other embodiments, however, the rack housing 302 may be secured within the mortice cut in the stile 116 via an interference fit or by using an adhesive.

The rack housing 302 houses one or more racks similar to or the same as the racks 124 in FIG. 1. In the illustrated embodiment, the rack housing 302 houses one or more first racks 124a (two shown) and one or more second racks 124b (two shown). The racks 124a,b may be movable from a stowed position fully received within the rack housing 302, as shown in FIGS. 3A-3B, to an extended position where the racks 124a,b protrude (extend) partially out of the rack housing 302. More specifically, each rack 124a,b defines teeth 306 configured to intermesh with corresponding teeth (not visible) defined on an adjacent pinion 308a or 308b operatively coupled to one of the handles 122a,b. Manual manipulation of the handles 122a,b between the first and second positions causes the corresponding pinions 308a,b to act on the adjacent racks 124a,b and thereby causes the corresponding rack 124a,b to partially displace laterally out of the rack housing 302 and simultaneously out of the vertical stile 116 (FIGS. 1A-1B and 2A-2B).

The first handle 122a is operatively coupled to the first pinions 308a such that movement of the first handle 122a correspondingly moves the first pinions 308a, which act on the corresponding first racks 124a via the intermeshed teeth 306. Similarly, the second handle 122b is operatively coupled to the second pinion(s) 308b such that movement of the second handle 122b correspondingly moves the second pinion(s) 308b, which act on the second racks(s) 124b via the intermeshed teeth 306.

In the illustrated embodiment, as best seen in FIG. 3B, each pinion shaft 202 of the first handle 122a extends through the trim plate 204 and is received within or otherwise coupled to a pinion spindle 310 rotatably mounted to the trim plate 204. The first pinions 308a are also received within or otherwise coupled to the corresponding pinion spindle 310. The pinion spindle 310 operates to transfer torque from the pinion shafts 202 to the first pinions 308a as the first handle 122a is manually manipulated between the first and second positions. Accordingly, as a user input force is applied to move the first handle 122a from the first position to the second position, torque is generated in the pinion shafts 202, which transfers to the first pinions 308a via the pinion spindle 310. The first pinions 308a then act on the adjacent first racks 124a and cause the corresponding racks 124a to move from the stowed position and partially displace laterally out of the rack housing 302. In at least one embodiment, instead of being separate and discrete component parts, the first pinions 308a may form integral extensions of the corresponding pinion shafts 202.

Each pinion spindle 310 may be rotatably mounted to the trim plate 204 on a pin 312 (partially visible) secured to the trim plate 204. Moreover, in some embodiments, each pinion spindle 310 may be spring loaded. More specifically, a helical coil spring 314 may be operatively coupled to each pinion spindle 310 and extend about the corresponding pin 312. As the first handle 122a is moved from the first position to the second position, spring force builds within the helical coil spring 314. Once the user input force on the first handle 122a is removed, the built up spring force is able to release and causes the first handle 122a to automatically rotate back toward the first position, which also correspondingly retracts the first racks 124a back to the stowed position within the rack housing 302 and the vertical stile 116 (FIGS. 1A-1B and 2A-2B).

The foregoing description of the operation and structure of the first handle 122a is substantially similar to the operation and structure of the second handle 122b. Accordingly, for the sake of brevity and to avoid duplicity, a detailed description of the operation and structure of the second handle 122b will not be provided.

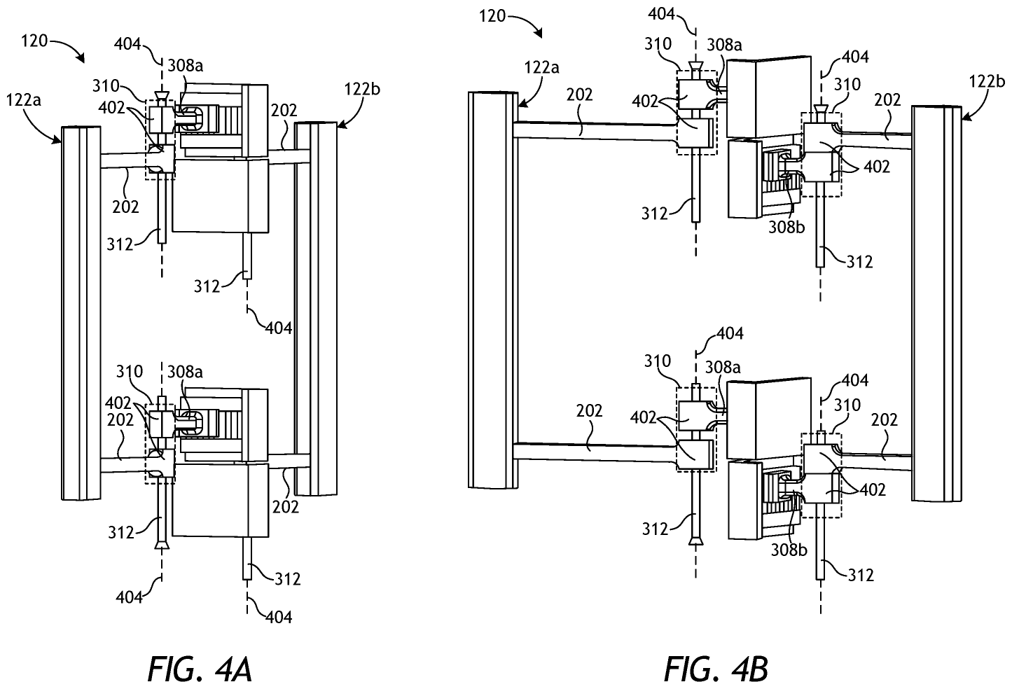

FIGS. 4A and 4B are left and right isometric views, respectively, of the handle assembly 120 of FIGS. 3A-3B. For ease of viewing particular parts of the handle assembly 120, the trim plates 204, the rack housing 302, and the helical coil springs 314 of FIGS. 3A-3B are omitted in FIGS. 4A-4B, and the pinion spindles 310 are depicted in dashed lines. In some embodiments, as illustrated, the pinion shafts 202 and the pinions 308a,b may each terminate in an enlarged head 402. The enlarged heads 402 may prove advantageous in coupling to and transferring torque to the pinion spindles 310. In other embodiments, however, the enlarged heads 402 may be omitted, without departing from the scope of the disclosure.

In some embodiments, the pins 312 extend through the adjacent ends of the pinion shafts 202 and the pinions 308a,b. In the illustrated embodiment, for example, the pins 312 extend through the enlarged heads 402 of the pinion shafts 202 and the pinions 308a,b. In other embodiments, the pins 312 may simply extend through the corresponding pinion spindle 310, but not through any portion of the pinion shafts 202 or pinions 308a,b.

In operation, the handles 122a,b may be configured to pivot about a pivot axis 404 extending through the pins 312. In the illustrated embodiment, the pinion shafts 202 extend from the handles 122a,b to the pivot axis 404, and the pinions 308a,b extend from the pivot axis 404 to engage the corresponding racks 124a,b. When a user applies a force on the handle 122a,b, that force will be augmented via a mechanical advantage based on the ratio between the corresponding lengths of the pinion shafts 202 and the pinions 308a,b about the hinged pivot axis 404. In some embodiments, these lengths can be optimized to obtain a mechanical advantage that causes the pinions 308a,b to generate an amplified axial force on the corresponding racks 124a,b against the stationary rack housing 302 by way of a proper meshing between the rack 124a,b and pinion 308a,b. In at least one embodiment, as indicated above, the handle assembly 120 may be configured to generate a mechanical advantage of 2.40 or more.

In some embodiments, the pinion shaft(s) 202 on one handle 122a,b may be longer than the pinion shaft(s) 202 on the other handle 122a,b. In the illustrated embodiment, for instance, and as best seen in FIG. 4B, the pinion shafts 202 extending from the first handle 122a are longer than the pinion shafts 202 extending from the second handle 122b. As will be appreciated, longer pinion shafts 202 may increase the mechanical advantage that the handle assembly 120 provides the user. Accordingly, the leverage can be increased by incorporating longer pinion shafts 202.

In some embodiments, the gearing ratio between the racks 124a,b and the pinions 308a,b, respectively, may also be altered to increase the mechanical advantage of the handle assembly 120. Since the gear ratio is equal to the pitch radius of the corresponding pinion 308a,b, with the pinion 308a,b as the input to the overall system and the rack 124a,b as the output, altering the gear ratio of the gear-train will contribute to the mechanical advantage of the pinion-rack gearset.

As indicated above, the first handle 122a is operatively coupled to the first pinions 308a such that movement of the first handle 122a correspondingly moves the first pinions 308a, and the second handle 122b is operatively coupled to the second pinion(s) 308b such that movement of the second handle 122b correspondingly moves the second pinions 308b. In one or more embodiments, as mentioned above, the separate and discrete pinion(s) 308a,b may alternatively form an integral part or extension of the pinion shaft(s) 202. In such embodiments, the pinion shaft(s) 202 may extend from the handle 122a,b and terminate in the pinion(s) 308a,b. Consequently, in such embodiments, the pinion spindles 310 may not be necessary. Instead, the pinion shafts 202 terminating in the pinions 308a,b will pivot about the pivot axis 404 extending through the pins 312.

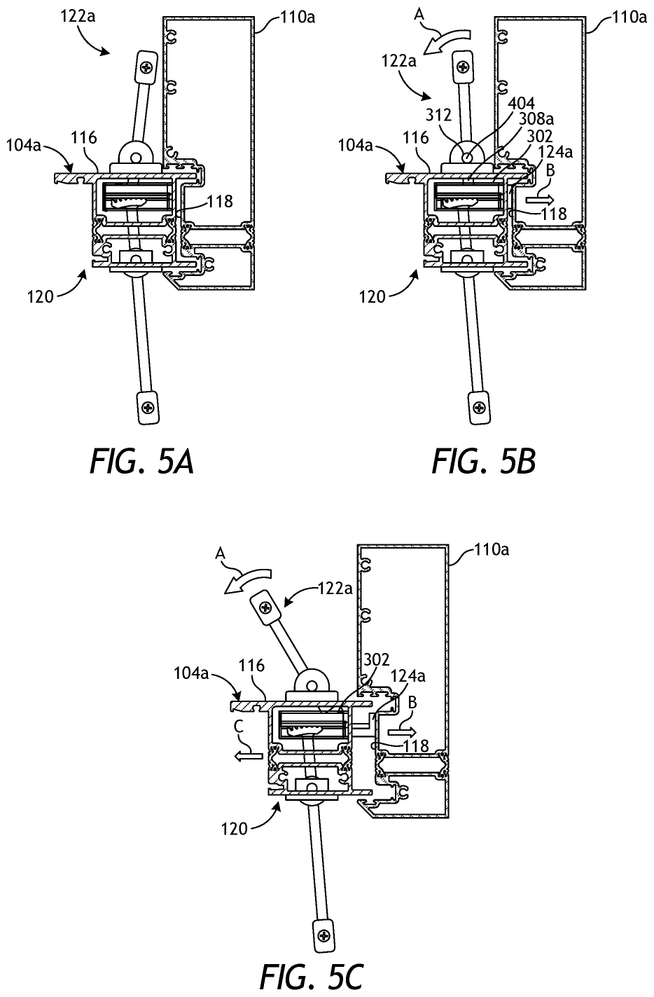

FIGS. 5A-5C are partial cross-sectional top views of the handle assembly 120 depicting example operation, according to one or more embodiments. More specifically, FIGS. 5A-5C show progressive movement of the first or “interior” handle 122a moving from the first position, as shown in FIG. 5A, to the second position, as shown in FIG. 5C, and thereby moving the sliding door panel 104a from the closed position to the open position. In FIG. 5A, the vertical stile 116 is partially received within the vertical weathered channel 118 defined by the first side member 110a. While not shown, one or more gaskets, seals, or “weathering piles” may be arranged within the weathered channel 118 and seal against the vertical stile 116 protruding into the weathered channel 118.

In FIG. 5B, the first handle 122a is moved slightly from the first position away from the first side member 110a in the direction indicated by the arrow A as it pivots about the pivot axis 404 running through the pins 312. As the first handle 122a pivots toward the second position, the first pinion(s) 308a act on the first rack(s) 124a via the opposing intermeshed teeth (not shown), which causes the first rack(s) 124a to start protruding from the rack housing 302 and engage the inner surface of the weathered channel 118, as shown by the arrow B.

In FIG. 5C, the first handle 122a is moved more fully away from the first side member 110a in the direction A and to the second position, which correspondingly causes the first rack(s) 124a to move to an extended position and bear against the inner surface of the weathered channel 118, as shown by the arrow B. Moving the first rack(s) 124a to the extended position applies a force against the first side member 110a that disengages the stile 116 from the weathered channel 118 and drives the sliding door panel 104a away from the first side member 110a and to the open position in the direction indicated by the arrow C.

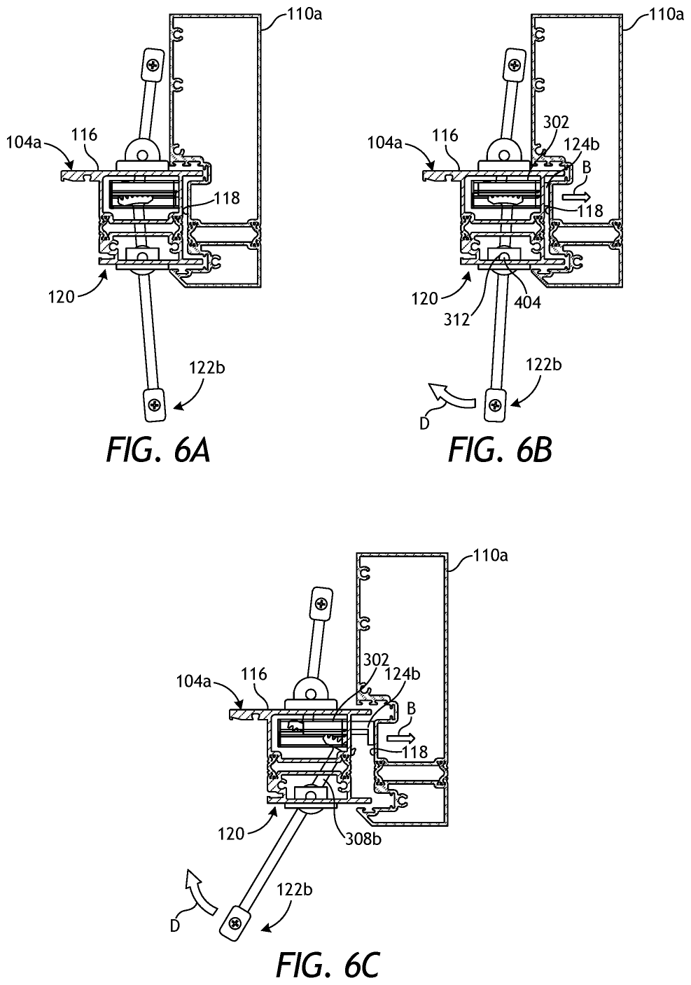

FIGS. 6A-6C are partial cross-sectional top views of the handle assembly 120 depicting example operation, according to one or more embodiments. More specifically, FIGS. 6A-6C show progressive movement of the second or “exterior” handle 122b moving from the first position, as shown in FIG. 6A, to the second position, as shown in FIG. 6C, and thereby moving the sliding door panel 104a from the closed position to the open position. In FIG. 6A, the vertical stile 116 is partially received within the vertical weathered channel 118 defined by the first side member 110a. While not shown, one or more gaskets, seals, or “weathering piles” may be arranged within the weathered channel 118 to seal against the vertical stile 116 protruding into the weathered channel 118.

In FIG. 6B, the second handle 122b is moved slightly from the first position away from the first side member 110a in the direction indicated by the arrow D as it pivots about the pivot axis 404 running through the pins 312. As the second handle 122b pivots toward the second position, the second pinion(s) 308b act on the second rack(s) 124b via the opposing intermeshed teeth 306, which causes the second rack(s) 124b to start protruding from the rack housing 302 and engage the inner surface of the weathered channel 118, as shown by the arrow B.

In FIG. 6C, the second handle 122b is moved more fully away from the first side member 110a in the direction D and to the second position, which correspondingly causes the second rack(s) 124b to move to an extended position and bear against the inner surface of the weathered channel 118, as shown by the arrow B. The protruding second rack(s) 124b applies a force against the first side member 110a that disengages the stile 116 from the weathered channel 118 and drives the sliding door panel 104a away from the first side member 110a and to the open position in the direction indicated by the arrow C.

In the embodiments described herein, the handles 122a,b do not require that a user tightly grip the handles 122a,b or twist the wrist to operate the handles 122a,b. Rather, a simple user input force as indicated by the arrows A and D in FIGS. 5A-5C and 6A-6C, respectively, need only be applied. Moreover, in some embodiments, as indicated above, one or both of the handles 122a,b may incorporate a roller grip 201 (FIGS. 2A-2B) that has freedom to rotate so the user can minimize the twisting of the wrist while applying force to rotate the pinion shaft to activate the mechanism.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

1. A sliding door system, comprising:
a stationary door frame;
a sliding door panel installed in the stationary door frame and movable between a closed position and an open position; and
a handle assembly coupled to the sliding door panel and including:
a rack housing installed within a vertical stile of the sliding door panel;
a rack positioned within the rack housing and movable between a stowed position and an extended position; and
a handle operatively coupled to a pinion engageable with the rack, the handle being pivotable about a pivot axis between a first position and a second position,
wherein rotating the handle from the first position to the second position causes the pinion to move the rack to the extended position and protrude from the rack housing and the vertical stile, whereby the rack is moved into engagement with the stationary door frame and the sliding door frame is thereby forced away from the stationary door frame from the closed position to the open position.

2. The sliding door system of claim 1, further comprising a weathered channel provided on a side member of the stationary door frame, the vertical stile being partially receivable within the weathered channel when the sliding door panel is in the closed position, and
wherein moving the rack to the extended position engages the rack on the side member and thereby disengages the vertical stile from the weathered channel.

3. The sliding door system of claim 1, wherein the handle assembly further includes:
a trim plate coupled to the vertical stile; and
a pin secured to the trim plate, wherein the pivot axis extends through the pin.

4. The sliding door system of claim 3, wherein the handle assembly further includes a pinion shaft extending laterally from the handle and through the trim plate via an aperture, and wherein the pinion shaft extends from the handle to the pivot axis, and the pinion extends from the pivot axis to engage the rack.

5. The sliding door system of claim 4, wherein a ratio between a length of the pinion shaft from the pivot axis and a length of the pinion from the pivot axis results in a mechanical advantage of at least 2.40.

6. The sliding door system of claim 4, further comprising a pinion spindle rotatably mounted to the pin, wherein an end of each of the pinion shaft and the pinion are coupled to the pinion spindle to transfer torque between the pinion shaft and the pinion.

7. The sliding door system of claim 6, further comprising a helical coil spring operatively coupled to the pinion spindle and extending about the pin.

8. The sliding door system of claim 1, wherein the handle is a first handle mounted on a first side of the vertical stile, the pivot axis is a first pivot axis, the rack is a first rack, and the pinion is a first pinion, and wherein the handle assembly further comprises:
a second rack positioned within the rack housing and movable between a stowed position and an extended position; and
a second handle mounted on a second side of the vertical stile and operatively coupled to a second pinion engageable with the second rack, the second handle being pivotable about a second pivot axis between a first position and a second position,
wherein rotating the second handle from the first position to the second position causes the second pinion to move the second rack to the extended position and into engagement with the stationary door frame, whereby the sliding door frame is forced away from the stationary door frame from the closed position to the open position.

9. A method of operating a sliding door system, comprising:
placing a load on a handle of handle assembly coupled to a sliding door panel installed in a stationary door frame, the handle assembly including:
a rack housing installed within a vertical stile of the sliding door panel; and
a rack positioned within the rack housing and movable between a stowed position and an extended position, wherein the handle is operatively coupled to a pinion engageable with the rack;
pivoting the handle about a pivot axis from a first position to a second position and thereby moving the rack to the extended position and into engagement with the stationary door frame; and
forcing the sliding door frame away from the stationary door frame with the rack and thereby moving the sliding door frame from the closed position to the open position.

10. The method of claim 9, wherein a weathered channel is provided on a side member of the stationary door frame, the method further comprising:
partially receiving the vertical stile within the weathered channel when the sliding door panel is in the closed position;
moving the rack toward the extended position and thereby engaging the rack on the side member; and
disengaging the vertical stile from the weathered channel as the rack moves to the extended position.

11. The method of claim 9, wherein the handle assembly further includes a trim plate coupled to the vertical stile, a pin secured to the trim plate and having the pivot axis extend therethrough, and a pinion shaft extending laterally from the handle and through the trim plate, wherein the pinion shaft extends from the handle to the pivot axis, and the pinion extends from the pivot axis to engage the rack.

12. The method of claim 11, further comprising obtaining a mechanical advantage of at least 2.40 based on a ratio between a length of the pinion shaft from the pivot axis and a length of the pinion from the pivot axis.

13. The method of claim 11, wherein the handle assembly further includes a pinion spindle rotatably mounted to the pin and an end of each of the pinion shaft and the pinion are coupled to the pinion spindle, the method further comprising transferring toque between the pinion shaft and the pinion with the pinion spindle.

14. The method of claim 13, wherein the handle assembly further includes a helical coil spring operatively coupled to the pinion spindle and extending about the pin, the method further comprising:
building spring force in the helical coil spring as the handle moves from the first position to the second position;
removing the load on the handle;
releasing the spring force in the helical coil spring and thereby moving the handle from the second position to the first position; and
moving the rack back to the stowed position as the handle moves from the second position to the first position.

15. The method of claim 9, wherein the handle assembly further includes a roller grip incorporated into the handle, the method further comprising rotating the roller grip about the handle as the handle pivots from the first position to the second position.

16. A handle assembly for a sliding door panel of a sliding door system, comprising:
a rack housing configured to be installed within a vertical stile of the sliding door panel;
a rack configured to be positioned within the rack housing and movable between a stowed position and an extended position; and
a handle operatively coupled to a pinion engageable with the rack, the handle being pivotable about a pivot axis between a first position and a second position,
wherein rotating the handle from the first position to the second position causes the pinion to move the rack to the extended position and protrude from the rack housing and the vertical stile.

17. The handle assembly of claim 16, further comprising:
a trim plate coupled to the vertical stile;
a pin secured to the trim plate, wherein the pivot axis extends through the pin;
a pinion shaft extending laterally from the handle and through the trim plate via an aperture,
wherein the pinion shaft extends from the handle to the pivot axis, and the pinion extends from the pivot axis to engage the rack.

18. The handle assembly of claim 17, wherein a ratio between a length of the pinion shaft from the pivot axis and a length of the pinion from the pivot axis results in a mechanical advantage of at least 2.40.

19. The handle assembly of claim 17, further comprising:
a pinion spindle rotatably mounted to the pin; and
a helical coil spring operatively coupled to the pinion spindle and extending about the pin,
wherein an end of each of the pinion shaft and the pinion are coupled to the pinion spindle to transfer torque between the pinion shaft and the pinion.

20. The handle assembly of claim 16, wherein the handle includes a roller grip.
